(19) United States
(12) Patent Application Publication
(10) Pub. No.: US 2026/0220279 A1
(43) Pub. Date: Jul. 30, 2026

(54) USER PRESENCE DETECT TO ENABLE A REMOTE SUPPORT AGENT AND SECURE USER CONTENT

(71) Applicant: DELL PRODUCTS L.P., Round Rock, TX (US)

(72) Inventors: Yung-Sheng Lin, Taoyuan City (TW); Shun-Tang Hsu, Taipei (TW); Daniel L. Hamlin, Round Rock, TX (US)

(21) Appl. No.: 19/037,075

(22) Filed: Jan. 24, 2025

(51) Int. Cl. G06F 21/60; G06F 21/31

(52) U.S. Cl. CPC G06F 21/60; G06F 21/31

(57) ABSTRACT

An information handling system includes a memory to store code and a processor to execute code. The code grants a remote access request to a support service, and blurs a portion of an image provided to the support service based upon a predetermined list of content in response to granting the remote access request. The portion includes at least one item of content from the list.

### FIELD OF THE DISCLOSURE

This disclosure relates to information handling systems, and more particularly relates to the use of user presence detect features to enable a remote support agent and to secure user content in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

An information handling system may include a memory to store code and a processor to execute code. The code may grant a remote access request to a support service, and blur a portion of an image provided to the support service based upon a predetermined list of content in response to granting the remote access request. The portion includes at least one item of content from the list.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an information handling system according to an embodiment of the present disclosure; and

FIG. 2 is a block diagram illustrating a generalized information handling system according to another embodiment of the present disclosure;

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

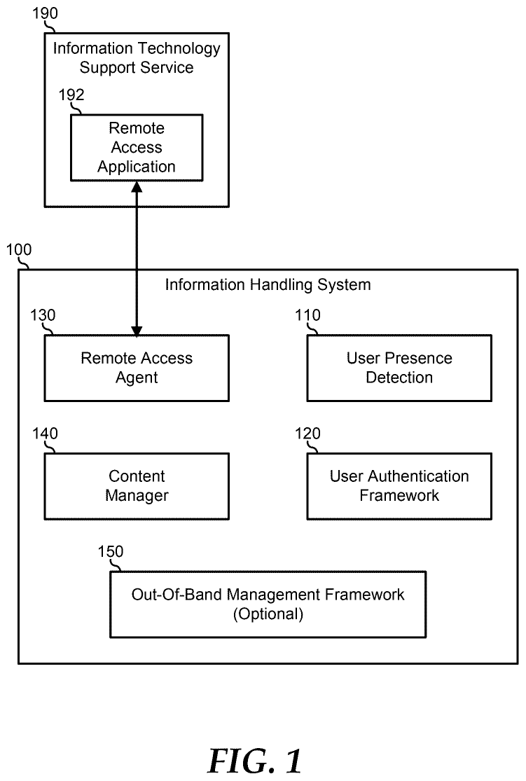

FIG. 1 illustrates an information handling system 100 including a User Presence Detect (UPD) framework 110, a user authentication framework 120, a remote access agent 130, and a content manager 140. UPD framework 110 represents hardware and firmware instantiated on information handling system 100 to detect various environmental inputs that operate to infer the presence of a user in the proximity of the information handling system. For example, UPD framework 110 may include various sensors such as an ambient light sensor, a microphone, a motion sensor, a camera/video device, or the like. UPD framework 110 operates to receive inputs from the various sensors and to determine whether or not a user is present in the proximity of information handling system 100.

User authentication framework 120 represents a security framework, typically embodied in software or firmware instantiated on information handling system 100. In this regard, when a user is detected by UPD framework 110, user authentication framework 120 operates to provide an identity of the user if the particular user is registered within the user authentication framework. In a particular case, when a particular user logs into an operating system for the first time, user authentication framework 120 may operate to prompt the user through various authentication processes and to set up authentication procedures to uniquely identify the user and to indelibly link that user with the particular log-in environment. For example, user authentication framework 120 may set up a username/password authentication, a personal identification number (PIN) authentication, a facial or fingerprint identification authentication, or the like. An example of user authentication framework 120 may include a Windows Hello framework or other third-party authentication frameworks, as needed or desired.

Information handling system 100 is illustrated as being connected to an information technology (IT) support service 190 that includes a remote access application 192. IT support service 190 represents a call-in and on-line support service whereby a user of information handling system 100 can obtain IT support for issues encountered by the user when using the information handling system. In a typical interaction, the user places a phone call or on-line service request, and a support technician of IT support services 190 is provided to talk or text the user through various troubleshooting procedures to identify the problem, and to fix the problem. In this regard, it is common for the IT support technician to invoke remote access application 192 to gain first-hand access to information handling system 100. The IT support technician may send an access request to information handling system 100. When the access request is granted, remote access agent 130 is invoked which grants user-level access to the resources of information handling system 100 to the IT support technician.

Such transactions may be conducted by authorized IT support technicians. That is, IT support services 190 may be a contracted entity or an in-house IT team, and the interactions between the IT support technician and information handling system 100 are trusted transactions. On the other hand, malicious actors are known to utilize bogus IT support services to attempt to gain access to the resources of information handling system 100, and thereby to access the user data of unwitting users. As such, it may be desirable to monitor and manage the access granted to IT support services 190, and to limit the IT support technician's ability to view sensitive data on information handling system 100.

In another case, even when IT support services 190 are trusted, a long support session may be difficult because UPD framework 110 and user authentication framework 120 typically operate to shut down information handling system 100 when no user presence is detected, or a different user is detected as being proximate to the information handling system. Thus, if the user needs a break or needs to attend a meeting, the operating system may shut down in the middle of a support session, leaving the user without a fix to the problem and having to restart a support session upon their return.

Content manager 140 represents a management framework, typically embodied in software or firmware instantiated on information handling system 100 to manage the interactions between the IT support technician and information handling system 100 and the sensitive user data displayed thereon. In one aspect, content manager 140 operates to provide for the blurring of sensitive content stored on information handling system 100 or displayed on a display device of the information handling system. In a particular case, content manager 140 provides the user of information handling system 100 with selectable options for content viewing, and the selected content is presumptively blurred for the remote support session. For example, the user may select particular content items to blur, such as office productivity files, or may select particular classes of content items to blur. The user may further select particular file folders or sub-folders to be blurred. In another case, content manager 140 operates based on rules-based or list-based instructions to blur content for the remote session. For example, content or folders displaying a project code name can be selected for blurring. In yet another case, an artificial intelligence/machine learning (AI/ML) model may be utilized to select which content is to be blurred and which content may be viewed in the remote support session.

In another aspect, content manager 140 operates to handle the behavior of the remote support session in the face of the varying UPD and authentication environment. In a particular case, content manager 140 operates to allow unblurred views into the resources and content on information handling system 100 when an authenticated user is proximate to the information handling system. Then, when the authenticated user leaves the proximity of information handling system 100 content manager 140 operates to blur the selected content. In this way, an authenticated user's presence is required for the IT support technician to have unfettered access to the resources and content of information handling system 100. Then, when the user authentication is broken (i.e., when an unautheticated user moves into the place of the authenticated user) or the authenticated user leaves the proximity of information handling system 100, content manager 140 alternatively provides a warning to the IT support technician that the remote support session is soon to be terminated, or overrides the functionality of UPD framework 110 and user authentication framework 120 to permit the OS to remain awake while the remote support session is in progress.

As illustrated and described heretofore, IT support service 190 operates with In-Band functionality of information handling system 100, that is, based upon a processing environment established on a processor of the information handling system (e.g. a BIOS/OS environment). In another case, information handling system 100 includes an optional Out-Of-Band (OOB) management framework 150. OOB management framework 150 represents hardware and firmware instantiated on information handling system 100 to implement an OOB management environment. In this regard, the functions and features of information handling system 100 may be instantiated via OOB management framework 150. However, because OOB management framework 150 operates OOB from the processing environment established on information handling system 100, a remote support session instantiated via the OOB management framework does not presumptively end when the OS goes to sleep. Thus, in this case, content manager 140 operates to permit the remote support session to continue when the UPD or user authentication is lost.

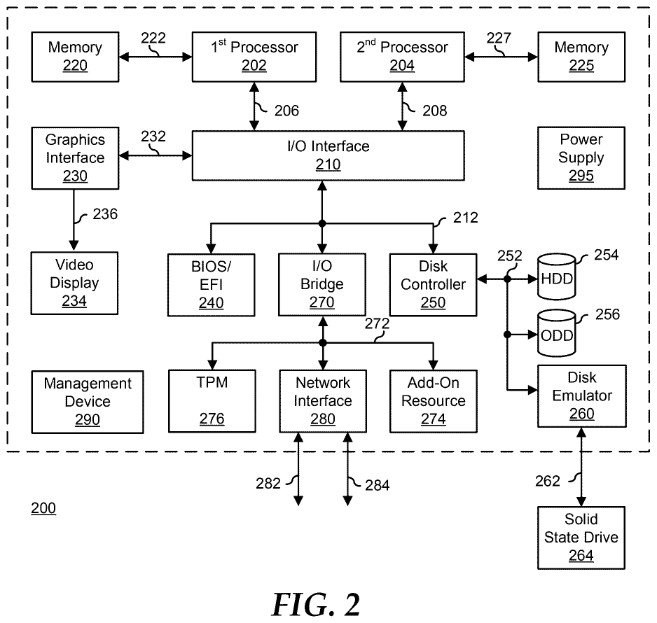

FIG. 2 illustrates a generalized embodiment of an information handling system 200 similar to information handling system 200. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 200 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 200 can include processing resources for executing machine-executable code, such as a central processing unit (CPU), a programmable logic array (PLA), an embedded device such as a System-on-a-Chip (SoC), or other control logic hardware. Information handling system 200 can also include one or more computer-readable medium for storing machine-executable code, such as software or data. Additional components of information handling system 200 can include one or more storage devices that can store machine-executable code, one or more communications ports for communicating with external devices, and various input and output (I/O) devices, such as a keyboard, a mouse, and a video display. Information handling system 200 can also include one or more buses operable to transmit information between the various hardware components.

Information handling system 200 can include devices or modules that embody one or more of the devices or modules described below, and operates to perform one or more of the methods described below. Information handling system 200 includes a processors 202 and 204, an input/output (I/O) interface 210, memories 220 and 225, a graphics interface 230, a basic input and output system/universal extensible firmware interface (BIOS/UEFI) module 240, a disk controller 250, a hard disk drive (HDD) 254, an optical disk drive (ODD) 256, a disk emulator 260 connected to an external solid state drive (SSD) 262, an I/O bridge 270, one or more add-on resources 274, a trusted platform module (TPM) 276, a network interface 280, a management device 290, and a power supply 295. Processors 202 and 204, I/O interface 210, memory 220, graphics interface 230, BIOS/UEFI module 240, disk controller 250, HDD 254, ODD 256, disk emulator 260, SSD 262, I/O bridge 270, add-on resources 274, TPM 276, and network interface 280 operate together to provide a host environment of information handling system 200 that operates to provide the data processing functionality of the information handling system. The host environment operates to execute machine-executable code, including platform BIOS/UEFI code, device firmware, operating system code, applications, programs, and the like, to perform the data processing tasks associated with information handling system 200.

In the host environment, processor 202 is connected to I/O interface 210 via processor interface 206, and processor 204 is connected to the I/O interface via processor interface 208. Memory 220 is connected to processor 202 via a memory interface 222. Memory 225 is connected to processor 204 via a memory interface 227. Graphics interface 230 is connected to I/O interface 210 via a graphics interface 232, and provides a video display output 236 to a video display 234. In a particular embodiment, information handling system 200 includes separate memories that are dedicated to each of processors 202 and 204 via separate memory interfaces. An example of memories 220 and 230 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 240, disk controller 250, and I/O bridge 270 are connected to I/O interface 210 via an I/O channel 212. An example of I/O channel 212 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 210 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 240 includes BIOS/UEFI code operable to detect resources within information handling system 200, to provide drivers for the resources, initialize the resources, and access the resources. BIOS/UEFI module 240 includes code that operates to detect resources within information handling system 200, to provide drivers for the resources, to initialize the resources, and to access the resources.

Disk controller 250 includes a disk interface 252 that connects the disk controller to HDD 254, to ODD 256, and to disk emulator 260. An example of disk interface 252 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 260 permits SSD 264 to be connected to information handling system 200 via an external interface 262. An example of external interface 262 includes a USB interface, an IEEE 1394 (Firewire) interface, a proprietary interface, or a combination thereof. Alternatively, solid-state drive 264 can be disposed within information handling system 200.

I/O bridge 270 includes a peripheral interface 272 that connects the I/O bridge to add-on resource 274, to TPM 276, and to network interface 280. Peripheral interface 272 can be the same type of interface as I/O channel 212, or can be a different type of interface. As such, I/O bridge 270 extends the capacity of I/O channel 212 where peripheral interface 272 and the I/O channel are of the same type, and the I/O bridge translates information from a format suitable to the I/O channel to a format suitable to the peripheral channel 272 where they are of a different type. Add-on resource 274 can include a data storage system, an additional graphics interface, a network interface card (NIC), a sound/video processing card, another add-on resource, or a combination thereof. Add-on resource 274 can be on a main circuit board, on separate circuit board or add-in card disposed within information handling system 200, a device that is external to the information handling system, or a combination thereof.

Network interface 280 represents a NIC disposed within information handling system 200, on a main circuit board of the information handling system, integrated onto another component such as I/O interface 210, in another suitable location, or a combination thereof. Network interface device 280 includes network channels 282 and 284 that provide interfaces to devices that are external to information handling system 200. In a particular embodiment, network channels 282 and 284 are of a different type than peripheral channel 272 and network interface 280 translates information from a format suitable to the peripheral channel to a format suitable to external devices. An example of network channels 282 and 284 includes InfiniBand channels, Fibre Channel channels, Gigabit Ethernet channels, proprietary channel architectures, or a combination thereof. Network channels 282 and 284 can be connected to external network resources (not illustrated). The network resource can include another information handling system, a data storage system, another network, a grid management system, another suitable resource, or a combination thereof.

Management device 290 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 200. In particular, management device 290 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 200, such as system cooling fans and power supplies. Management device 290 can include a network connection to an external management system, and the management device can communicate with the management system to report status information for information handling system 200, to receive BIOS/UEFI or system firmware updates, or to perform other task for managing and controlling the operation of information handling system 200. Management device 290 can operate off of a separate power plane from the components of the host environment so that the management device receives power to manage information handling system 200 where the information handling system is otherwise shut down. An example of management device 290 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 290 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed:

1. An information handling system, comprising:
a memory device configured to store code; and
a processor configured to execute code to:
grant a remote access request to a support service; and
blur a portion of an image provided to the support service based upon a predetermined list of content in response to granting the remote access request, wherein the portion includes at least one item of content from the list.

2. The information handling system of claim 1, wherein blurring the portion of the image is in response to determining that a user is proximate to the information handling system.

3. The information handling system of claim 2, further comprising:
User Presence Detect (UPD) configured to determine that the user is proximate to the information handling system.

4. The information handling system of claim 3, wherein blurring the portion of the image is in further response to determining that the user is an authenticated user of the information handling system.

5. The information handling system of claim 4, further comprising:
an authentication framework configured to authenticate the user.

6. The information handling system of claim 1, wherein blurring the portion of the image is in response to determining that a user is not proximate to the information handling system.

7. The information handling system of claim 6, wherein, prior to blurring the portion of the image, the code is further to determine that the user is proximate to the information handling system.

8. The information handling system of claim 7, wherein, after determining that the user is not proximate to the information handling system, the code is further to maintain a session with the support service.

9. The information handling system of claim 1, further comprising:
out-of-band management hardware configured to initiate a support session in response to granting the remote access request.

10. A method, comprising:
granting, by a processor of an information handling system, a remote access request to a support service; and
blurring a portion of an image provided to the support service based upon a predetermined list of content in response to granting the remote access request, wherein the portion includes at least one item of content from the list.

11. The method of claim 10, wherein blurring the portion of the image is in response to determining that a user is proximate to the information handling system.

12. The method of claim 11, further comprising:
determining, by User Presence Detect (UPD) hardware of the information handling system, that the user is proximate to the information handling system.

13. The method of claim 12, wherein blurring the portion of the image is in further response to determining that the user is an authenticated user of the information handling system.

14. The method of claim 13 further comprising:
authenticating, by an authentication framework of the information handling system, the user.

15. The method of claim 10, wherein blurring the portion of the image is in response to determining that a user is not proximate to the information handling system.

16. The method of claim 15, wherein, prior to blurring the portion of the image, the method further comprises:
determining that the user is proximate to the information handling system.

17. The method of claim 16, wherein, after determining that the user is not proximate to the information handling system, the method further comprises:
maintaining a session with the support service.

18. The information handling system of claim 10, further comprising:
initiating, by out-of-band management hardware of the information handling system, a support session in response to granting the remote access request.

19. An information handling system, comprising:
a memory device configured to store code; and
a processor configured to execute code to:
grant a remote access request to a support service;
blur a portion of an image provided to the support service based upon a predetermined list of content in response to granting the remote access request, wherein the portion includes at least one item of content from the list, and wherein blurring the portion of the image is in response to determining that a user is proximate to the information handling system;
User Presence Detect (UPD) configured to determine that the user is proximate to the information handling system; and
out-of-band management hardware configured to initiate a support session in response to granting the remote access request.

20. The information handling system of claim 19, wherein blurring the portion of the image is in further response to determining that the user is an authenticated user of the information handling system.
